(19) United States
(12) Patent Application Publication
(10) Pub. No.: US 2007/0182920 A1
(43) Pub. Date: Aug. 9, 2007

(54) Corneal Onlays and Related Methods

(75) Inventors: Arthur Back, Pleasanton, CA (US); J. Christopher Marmo, Pleasanton, CA (US); Malik Hakim, Pleasanton, CA (US); Gregg A. Dean, Southampton (GB)

Correspondence Address: FRANK J. UXA, STOUT, UXA, BUYAN & MULLINS, LLP, 4 VENTURE, SUITE 300, IRVINE, CA, 92618, US

(73) Assignee: COOPERVISION, INC., Fairport, CA (US)

(21) Appl. No.: 11/672,388

(22) Filed: Feb. 7, 2007

Related U.S. Application Data
(60) Provisional application No. 60/771,668, filed on Feb. 8, 2006.
(60) Provisional application No. 60/747,355, filed on May 16, 2006.

(51) Int. Cl. G02C 7/04

(52) U.S. Cl. 351/160 R

(57) ABSTRACT

Corneal onlays and method of making and using corneal onlays are described. The present corneal onlays may have clinically acceptable lens bodies for use in human eyes. The present corneal onlays may have one or more physical features that contribute to the success of the present onlays in human eyes.

### CROSS-REFERENCE TO RELATED APPLICATIONS

This application claims the benefit of U.S. provisional Application No. 60/771,668, filed Feb. 8, 2006, and U.S. provisional Application No. 60/747,355, filed May 16, 2006, the contents of which in their entireties are hereby incorporated by reference.

### FIELD OF THE INVENTION

The present invention relates to ocular prostheses. More particularly, the invention relates to corneal onlays and methods of producing and using same.

### BACKGROUND

Photo-refractive keratectomy (PRK) and laser-assisted in situ keratomileusius (LASIK) are procedures performed on patients to improve a patient's vision by ablating intrastromal corneal tissue. Corneal onlays have been proposed as an alternative to these procedures. A corneal onlay may be understood to be a corneal implant, and more specifically, an implantable lens, that is placed between Bowman's membrane of the cornea of an eye and the corneal epithelium of the eye. Since corneal onlays are devices implanted into the eye of a patient, corneal onlays provide the opportunity to improve a patient's vision for long periods of time, but also provide a reversible procedure to correct refractive error. These procedures may result in improvements in a patient's vision without the need for spectacles or contact lenses.

Early approaches of using corneal onlays required complete removal or abrasion of the corneal epithelium to expose the underlying Bowman's membrane. It was postulated that placement of a corneal onlay on a deepithelialized Bowman's membrane would be helpful in improving a patient's vision. However, such procedures required the corneal epithelial cells to grow and migrate over the corneal onlay. These approaches were unsuccessful and have not resulted in a clinically acceptable corneal onlay for improving a human patient's vision. For example, implants made of donor corneal tissue or polymerized collagen or other high water content lens materials have been reported to suffer from epithelial abnormalities, incomplete epithelialization, remodelling of the implant, and/or neovascularization of the implant (McDonald, “The future direction of refractive surgery”, J. Refract Surg., 4:158-168, 1988; Latkany et al., “Plasma surface modification of artificial corneas for optimal epithelialization”, J. Biomed Mater Res, 36:29-37, 1997; Trinkaus-Randall et al., “Implantation of a synthetic cornea: design, development and biological response”, Artificial Organs, 21:1185-1191, 1997). Some patents which describe potential materials for corneal implants include U.S. Pat. Nos. 5,156,622; 5,163,956; 5,836,313; 5,632,773; 6,060,530; 6,015,609; and 6,361,560, and U.S. Patent Publication No. 20050196427.

More recently, procedures for implanting corneal onlays have been proposed which include implanting a corneal onlay under a corneal epithelial flap or in a corneal epithelial pocket. These approaches however have not currently resulted in a clinically acceptable corneal onlay for improving a patient's vision. For example, see U.S. Patent Publication Nos. 20030220653; 20050070942; 20050080484; and 20050124982.

It has been reported that implants made from biologically-derived materials are unable to sustain multi-layered corneal epithelium over the anterior or exterior surface of the implant and do not have a sufficient biostability to provide the necessary visual outcome or desired clinical performance (Evans et al., Biomaterials, 22:3319-3328, 2001). Corneal implants made of non-biologically derived materials, or synthetic materials, have been described which are intended to be incorporated into the cornea during a normal epithelial wound healing response involving the migration, stratification, and adhesion of recipient corneal epithelium over the anterior surface of the implant (Evans et al., Investigative Ophthalmology & Visual Science, 43(10):3196-3201, 2002). Such corneal implants are made from an iso-refractive polymer and achieve a desired refractive error correction by changing the curvature of the corneal surface. However, synthetic corneal implants also can experience problems, such as poor epithelial growth, and substantial differences in properties can be observed between in vitro experiments and in vivo experiments (Sweeney et al., Invest. Ophthalmol. Vis. Sci., 40(4):ARVO Abstract 638, 1999; Evans et al., Invest Ophthalmol. Vis. Sci., 41:1674-80, 2000; Trinkaus-Randall et al., Artif. Organs., 21:1185-91, 1997; and Latkany et al., J. Biomed. Mater. Res., 36:29-37, 1997). A number of polymeric materials have been described as potential substrates for corneal onlays (e.g., see U.S. Pat. Nos. 5,156,622; 5,163,956; 5,565,519; 5,744,545; 5,832,313; and 5,632,773).

The lack of success in obtaining a clinically acceptable corneal onlay may be attributed to the requirements to provide a lens of a desired optical power with material, physical, and optical properties to provide a desired vision correction, maintain corneal epithelial health, and ease of use during a clinical procedure. Lack of success may also be related to manufacturing requirements of the corneal onlays which are required to ensure desirable or acceptable optical properties and reproducibility.

Thus, there remains a need for new corneal onlays that are clinically acceptable and that can provide a vision improvement for a clinically acceptable period of time.

### SUMMARY

The present corneal onlays and methods attempt to address this and other needs. The present corneal onlays provide for long term correction of refractive error or improvement of vision in a convenient procedure. Use of the present corneal onlays provides an improvement in vision of a human patient without requiring repeated application and removal of contact lenses, and without causing substantial weakening or damage to corneal structures such as the corneal stroma. The present corneal onlays are comfortable to the patient and remain optically transparent for extended periods of time.

The present corneal onlays comprise a lens body. The lens body has an anterior surface and a posterior surface. When placed in an eye, the anterior surface will be covered by the corneal epithelium and the posterior surface will be facing, adjacent to, or in contact with Bowman's membrane of the cornea. The lens body may have an outer peripheral edge and an optic zone. The lens body may also have one or more non-optic zones.

In certain embodiments, a corneal onlay comprises a clinically acceptable lens body. The lens body remains optically transparent while placed in a patient's eye. A clinically acceptable lens body may be related to one or more properties or features of the lens body, such as the physical shape of the lens body, the physical properties of the lens body, the chemical properties of the lens body, and the process for preparing the lens body.

Certain embodiments relate to a corneal onlay that comprises a lens body having specific lens edge features, including outer peripheral edge thicknesses. Certain embodiments relate to a corneal onlay that comprises a lens body having specific rates of change in thickness from the edge toward the center of the lens body. Certain embodiments relate to a corneal onlay that comprises a lens body having specific sagittal depths. Certain embodiments relate to a corneal onlay that comprises a lens body having specific power profiles.

Other aspects of the present invention related to methods of making the present corneal onlays. In certain embodiments, the methods are effective in making corneal onlays that are substantially free of microscopic defects.

Other aspects of the present invention relate to the use of the present corneal onlays, for example, the use of a corneal onlay in a method of improving vision of a patient.

An additional aspect of the present invention relates to methods of identifying or screening clinically acceptable corneal onlays.

Various embodiments of the present invention are described in detail in the detailed description and additional disclosure below. Any feature or combination of features described herein are included within the scope of the present invention provided that the features included in any such combination are not mutually inconsistent as will be apparent from the context, this specification, and the knowledge of one of ordinary skill in the art. In addition, any feature or combination of features may be specifically excluded from any embodiment of the present invention. Additional advantages and aspects of the present invention are apparent in the following detailed description, drawings, examples, and additional disclosure.

### BRIEF DESCRIPTION OF THE DRAWINGS

FIG. 1 is a plan view of one of the present corneal onlays.

FIG. 2 is a sectional view of the corneal onlay of FIG. 1 along line II-II.

FIG. 3 is a section view of another corneal onlay.

FIG. 4 is a plan view of the anterior surface of another corneal onlay.

FIG. 5 is a section view of a corneal onlay showing the sagittal depth of the corneal onlay.

FIG. 6 is a magnified sectional view of a lens edge region of a corneal onlay.

FIG. 7 is a graph illustrating ramp rate (mm/mm) as a function of optical power (diopters).

### DETAILED DESCRIPTION

Corneal onlays have been invented which provide a desired improvement or enhancement in vision to a human patient with reduced adverse side effects and improvements in properties compared to other previously described or used corneal onlays. As used herein, a corneal onlay refers to a corneal implant or corneal prosthesis, such as a lens or lenticule, that is structured for placement on the Bowman's membrane of a cornea of an eye of a human patient. In other words, a corneal onlay is an implant that has a surface that contacts Bowman's membrane when the corneal onlay is placed on or in a cornea of a patient.

The human cornea consists of five layers, namely, the corneal epithelium, the Bowman's membrane, the stroma, Descemet's membrane, and the endothelium. The corneal epithelium usually is about 5-6 cell layers thick (approximately 50 micrometers thick), and generally regenerates when the cornea is injured. The corneal epithelium lines the anterior or exterior surface of cornea, provides a relatively smooth refractive surface, and helps prevent infection of the eye. The corneal stroma is a laminated structure of collagen which contains cells, such as fibroblasts and keratocytes, dispersed therein. The stroma constitutes about 90% of the corneal thickness. The anterior portion of the stroma, which underlies the epithelium, is acellular and is known as Bowman's membrane. Bowman's membrane is located between the epithelium and the stroma and is believed to protect the cornea from injury. The corneal endothelium typically is a monolayer of low cuboidal or squamous cells that dehydrates the cornea by removing water from the cornea. An adult human cornea is typically about 500 μm (0.5 mm) thick and is typically devoid of blood vessels.

After a successful corneal onlay implantation procedure, the corneal onlay is located between the Bowman's membrane and the corneal epithelium. It can be understood that the corneal epithelium covers and contacts an anterior surface of the corneal onlay, and that Bowman's membrane is in contact with the posterior surface of the corneal onlay. Thus, corneal onlays are different and distinct from contact lenses which are placed over the corneal epithelium and corneal inlays which are placed in the corneal stroma.

The present corneal onlays described herein are clinically acceptable when placed in human corneas. For example, the present corneal onlays have a clinically acceptable optical clarity or transparency, a clinically acceptable lens design, a clinically acceptable nutrient transmissibility or permeability, a clinically acceptable biocompatibility or toxicity (e.g., the corneal onlays are non-toxic), and/or a clinically acceptable biostability. Such clinical acceptability is determined by a medical practitioner, such as a physician or licensed eye care professional, or by the patient provided with the corneal onlay. Clinical acceptability can be reported on a qualitative or quantitative scale using routine methods and scales known to persons of ordinary skill in the art.

For example, with the present corneal onlays, a healthy and functioning corneal epithelium can be maintained after an implantation or surgical procedure for extended periods of time. The healed corneal epithelium successfully covers the corneal onlay and receives sufficient nutrients, water, ions, and other factors necessary for epithelial cell function and overall ocular health. The healed epithelium effectively functions as a normal epithelium prior to implantation of the corneal onlay on or in the cornea of an eye. For example, the epithelium maintains a stable tear film, provides protection to the corneal onlay and to the eye generally, and provides an ophthalmically acceptable refractive index. The present corneal onlays promote and/or maintain epithelial adherence to the onlay, which may be effective in reducing decentration of the corneal onlay relative to the optic axis of a patients eye. As discussed herein, embodiments of the present corneal onlays also may be structured, such as sized and shaped, to support or maintain a desirable migration and proliferation of corneal epithelial cells on or over the corneal onlay.

The present corneal onlays are structured or physically configured to optimize comfort to the human patient while providing a desired improvement or enhancement in vision. For example, successful vision improvement can be obtained with the present corneal onlays with reduced discomfort compared to the discomfort that is often associated with PRK. Desirably, after implantation or placement of the present corneal onlays on Bowman's membrane, and after a healing time period, a stable tear film is maintained on the exterior surface of the eye, and overall dryness and/or ocular irritation is minimized. With the present corneal onlays, biochemical and microbiological contamination are minimized. Accordingly, the present corneal onlays can be implanted in the cornea of an eye with reduced inflammation and/or bacterial contamination, even without the use of additional anti-bacterial agents.

In addition, the present corneal onlays are formed from a material or materials suitable for a corneal implant without being rejected by the patient or the patient's eye. For example, the corneal onlays can be implanted in a cornea of a patient without causing an antigenic or immunogenic response by the patient. As discussed herein, embodiments of the present corneal onlays are substantially free or entirely free of donor corneal tissue. The present corneal onlays are associated with reduced opacities of the onlay, reduced epithelial ingrowth or undergrowth, and reduced corneal epithelial defects compared to existing or described corneal onlays. In addition, implantation of the present corneal onlays is not associated with neovascularization of the onlays or other corneal structures, including the corneal epithelium, and does not negatively affect the structural integrity of the patient's cornea.

The present corneal onlays are relatively easy to implant in a patient's eye and can be performed as an in-office medical procedure, as described herein. The present corneal onlays can provide reduced visual down time comparable to other procedures, such as PRK and LASIK procedures, and provide stable refractive vision correction relative to LASIK procedures since the integrity of the corneal stroma is maintained. As discussed herein, embodiments of the present corneal onlays may be structured to treat or correct moderate or high refractive errors, such as high myopia and aphakia.

The present corneal onlays remain clinically acceptable for relatively long periods of time after placement on Bowman's membrane. For example, the present corneal onlays may remain clinically acceptable for at least about 6 months after surgical implantation. Certain embodiments of the present corneal onlays remain clinically acceptable for at least 1 year, at least 5 years, at least 10 years, at least 20 years, or the entire remaining life of the patient. In other words, the present corneal onlays remain optically clear so as not to cause a negative effect on a patient's vision, may not degrade, be rejected, or cause an adverse biological reaction for years after the onlay is placed in the eye. However, in situations where the patient's vision changes or an improved onlay is desired, and the like, the present corneal onlays can be easily removed from the eye of the patient, as desired.

Reference will now be made in detail to the present embodiments of the invention, some examples of which are illustrated in the accompanying drawings. Wherever possible, the same or similar reference numbers are used in the drawings and the description to refer to the same or like parts. It should be noted that the drawings are in simplified form and are not to precise scale. In reference to the disclosure herein, for purposes of convenience and clarity only, directional terms, such as, top, bottom, left, right, up, down, over, above, below, beneath, rear, front, backward, forward, distal, proximal, anterior, posterior, superior, inferior, temporal, and nasal are used with respect to the accompanying drawings. Such directional terms should not be construed to limit the scope of the invention in any manner.

Although the disclosure herein refers to certain embodiments, it is to be understood that these embodiments are presented by way of example and not by way of limitation. The intent of the following detailed description, although discussing exemplary embodiments, is to be construed to cover all modifications, alternatives, and equivalents of the embodiments.

The present corneal onlays comprise a lens body. The lens body has an anterior surface and a posterior surface. The anterior surface of the lens body is covered by the corneal epithelium after a corneal implantation procedure. The posterior surface of the lens body is adjacent, in contact with, or facing Bowman's membrane after a corneal implantation procedure. The anterior surface and the posterior surface of the lens body meet or come in contact at an edge region. Thus, it may be understood that the lens body comprises an outer peripheral edge. The lens body of the present corneal onlay also has an optic zone. The optic zone may refer to the entire lens body or it may refer to a portion thereof. When the lens body has an optic zone that is smaller than the entire lens body, the lens body may also have a non-optic zone or zones, as discussed herein.

Certain embodiments of the present corneal onlays comprise a clinically acceptable lens body. As discussed herein, clinical acceptability is determined by a medical practitioner and/or a human patient provided with the present corneal onlays. Clinical acceptability includes, without limitation, ophthalmically acceptable clarity or transparency of the lens body, ophthalmically acceptable corneal epithelial anatomy and physiology, and/or ophthalmically acceptable ocular health. A clinically acceptable lens body is comfortable to the patient, provides a prescribed or desired vision correction to the patient, and/or does not cause inflammation or ocular irritation to the patient. The clinically acceptable lens body has an anterior surface and a posterior surface. In at least one embodiment, the lens body is effective in permitting a corneal epithelium to completely heal and cover the anterior surface of the lens body, and is effective in retaining an ophthalmically acceptable transparency after implantation of the lens body onto the cornea of an eye of a human patient.

The lens body of the present corneal onlays may be understood to be biocompatible with the cornea of the patient. Or, stated differently, the lens body has an ophthalmically acceptable biocompatibility. For example, the lens body does not illicit an adverse reaction with the patient's eye. The lens body may be understood to have a nutrient transmissibility effective in maintaining a living corneal epithelium over the anterior surface of the lens body.

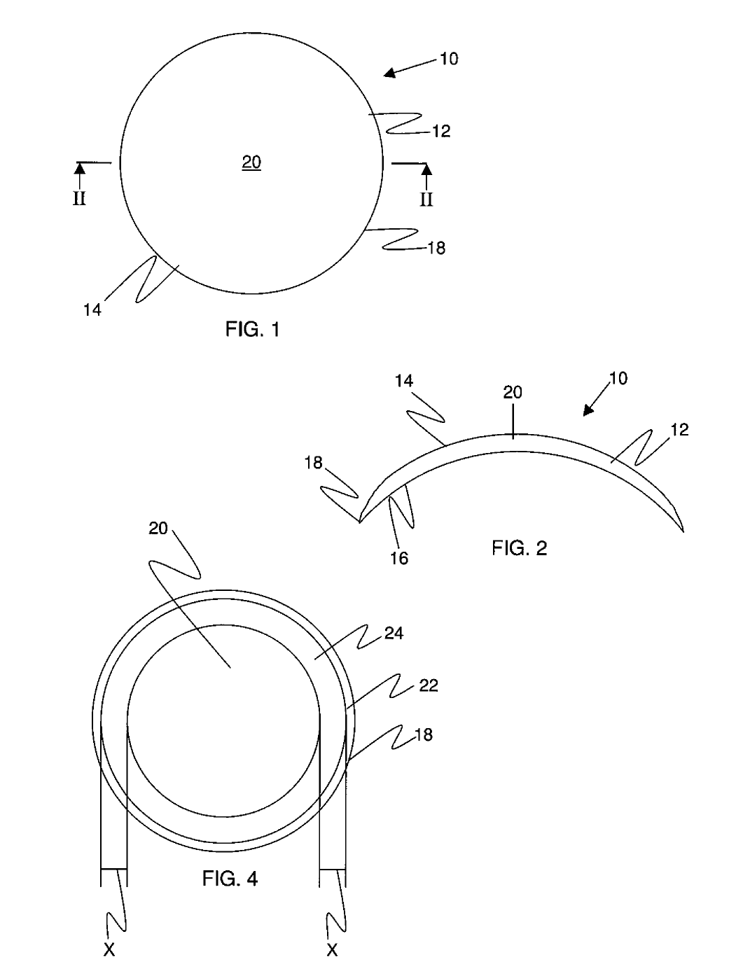

An example of a corneal onlay 10 is illustrated in FIG. 1. The corneal onlay 10 comprises a lens body 12 having an anterior surface 14 and a posterior surface 16 (see FIG. 2). The lens body 12 has an outer peripheral edge 18. As shown in FIG. 2, the outer peripheral edge 18 is located at the junction of the anterior surface 14 and the posterior 16. Or, stated differently, the lens body 12 shown in FIG. 2 has an anterior surface 14 and a posterior surface 16 that contact each other at outer peripheral edge 18.

As discussed herein, the outer peripheral edge of the lens body can have certain physical configurations. For example, the outer peripheral edge may have one or more rounded portions, such as a rounded posterior portion, a rounded anterior portion, or a rounded posterior and anterior portion. The outer peripheral edge may include an apex which can be understood to be a point (when viewed in a cross-sectional view) where an anterior portion of a lens edge region and a posterior portion of a lens edge region contact each other. The apex may be located at the radially outermost point of the lens body posterior surface or the apex may be located anterior relative to the posterior surface of the lens body. In other words, the apex may be located along the curvature of the posterior surface of the lens body (e.g., the apex is the radially outermost point of the lens body posterior surface), or the apex may be located at a distance greater than zero from the posterior surface towards the anterior surface. When the apex is located at the radially outermost point of the lens body posterior surface, the apex may be understood to be the outer peripheral edge.

The lens body 12 also has an optic zone 20. The optic zone 20 may be provided as a portion of the lens body 12 or it may be provided as the entire lens body 12. The optic zone 20 covers the pupil of an eye and provides a desired optical power to provide a desired vision improvement, such as a correction of refractive error. In embodiments of corneal onlays in which the optic zone 20 is a portion of the lens body, the lens body may comprise one or more non-optic zones.

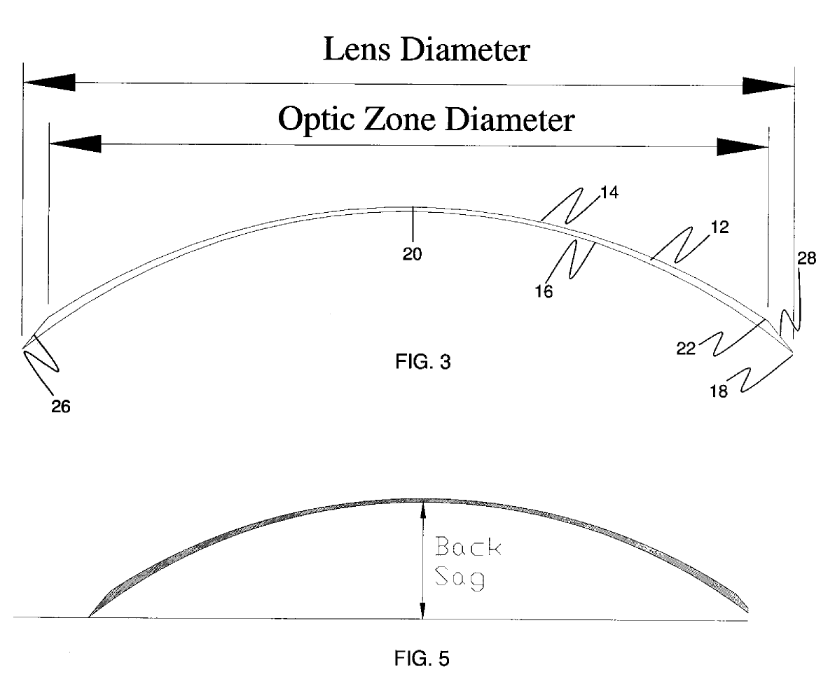

As shown in FIG. 3, a lens body 12 has an optic zone 20. The optic zone 20 has an optic zone outer perimeter 22. For a circular optic zone, the optic zone outer perimeter 22 circumscribes the optic zone 20. The optic zone outer perimeter 22 is spaced apart from the outer peripheral edge 18, for example, the optic zone outer perimeter 22 is located radially inward relative to the outer peripheral edge 18. The optic zone 20 of the corneal onlay 10 shown in FIG. 3 is thus defined as the portion of the lens body 12 that is located within the optic zone outer perimeter 22. In the embodiment shown in FIG. 3, the optic zone 20 extends from the optic zone outer perimeter on one side of the lens body, such as the superior, inferior, nasal, or temporal side of the lens body) to the optic zone outer perimeter on the opposing side of the lens body. It may also be understood that the optic zone 20 has a diameter, and in the embodiment of FIG. 3, the optic zone diameter corresponds to the diameter of the optic zone outer perimeter.

The optic zone may also be understood to have an optic zone periphery. The optic zone periphery may be defined as a region adjacent to and radially inward of the optic zone perimeter 22. For example, as shown in FIG. 4, the optic zone periphery 24 is adjacent optic zone outer perimeter 22 and has two radial lengths X. In certain embodiments, the optic zone periphery may be understood to have a total radial length that is less than 60% of the diameter of the optic zone. For example, the total radial length of the optic zone periphery may be about 50%, or about 40%, or about 30%, or about 20%, or about 10%, or about 5% of the optic zone diameter. In a circular lens body, the total radial length of the optic zone periphery refers to the sum of the radial length of the optic zone periphery on one side of the optic center of the lens body and the radial length of the optic zone periphery on an opposing second side of the lens body. As shown in FIG. 4, the optic zone periphery 24 has a total radial length equal to 2X, where X is the radial length of the optic zone periphery 24 on one side of the lens body. Although the illustrated corneal onlay shown in FIG. 4 shows discrete boundaries of the optic zone periphery 24, it is to be understood that in the present corneal onlays, the optic zone periphery may be defined as a distance, and may not have a visually identifiable junction defining its boundaries.

As discussed herein, the lens body of a corneal onlay have one or more non-optical zones. As shown in FIG. 3, the lens body 12 has a non-optic zone 26 located between the optic zone outer perimeter 22 and the outer peripheral edge 18. In the embodiment illustrated in FIG. 3, the non-optic zone 26 is referred to as a ramp zone 28. As used herein, a “non-optic zone” refers to a portion of the lens body that is visually identifiable and distinguishable from the optic zone of the lens body. The phrase “non-optic zone” does not mean that the non-optic zone is not optically clear. For example, as discussed herein, the non-optic zone is preferably optically transparent or has a transparency or refractive index equal to the transparency or refractive index of the optic zone. However, in certain embodiments, the non-optic zone may have a different transparency or refractive index compared to the transparency or refractive index of the optic zone.

As shown in FIG. 3, embodiments of the present corneal onlays may comprise a lens body that has an optic zone 20 having an optic zone outer perimeter 22, and outer peripheral edge 18 located at the junction of the anterior surface 14 and the posterior surface 16, and a ramp zone 28 located between the outer peripheral edge 18 and the optic zone outer perimeter 22. The outer peripheral edge 18 is spaced apart from the optic zone outer perimeter 22.

The outer peripheral edge 18 or the lens edge region of the lens body 12 of the present corneal onlays 10 has a thickness effective in promoting and or maintaining normal corneal epithelium anatomical and physiological properties. The lens edge region may be understood to correspond to a region of the lens body that has a length radially extending from the outer peripheral edge 18 toward or to the optic zone outer perimeter 22. The radial length of the lens edge region is less than 3.5 mm for most corneal onlays. For example, a corneal onlay comprising a lens body having a 12 mm lens diameter and a optic zone with a 5 mm diameter can be understood to have a lens edge region with a radial length of 3.5 mm. In certain embodiments, the lens edge region may have a radial length on one side of the lens body less than one hundred micrometers (i.e., 0.1 mm). In other embodiments, the lens edge region may have a radial length on one side of the lens body greater than 0.1 mm. For example, the lens edge region may have a radial length less than or equal to fifty micrometers, or less than or equal to forty micrometers, or less than or equal to thirty micrometers, or less than or equal to twenty micrometers, or less than or equal to ten micrometers.

The thickness of the outer peripheral edge 18 or lens edge region, such as the radially outermost thirty micrometers of the lens body, has a thickness effective in maintaining a living corneal epithelium that comprises stratified layers of corneal epithelial cells which maintain normal corneal epithelial cell function, as described herein. The thickness of the outer peripheral edge or lens edge region of the present corneal onlays may vary depending on the implantation procedure. For example, the thickness of the outer peripheral edge or lens edge region for a corneal onlay that is placed on a epithelially debraded cornea may be different than the thickness of the outer peripheral edge or lens edge region of a corneal onlay that is placed under a corneal epithelium flap or in a corneal epithelial pocket.

Certain embodiments of the present corneal onlays comprise a lens body having an outer peripheral edge that has a thickness less than a maximum dimension of a living corneal epithelial cell. The outer peripheral edge may have a thickness that is effective in preventing adverse or any corneal epithelial cell growth under the lens body while not reducing or adversely affecting corneal epithelial cell growth over the lens body. For example, the outer peripheral edge may have a thickness less than ten micrometers. In certain embodiments, the outer peripheral edge has a thickness less than seven micrometers. In other words, embodiments of the present corneal onlays may comprise a lens body having an outer peripheral edge thickness no greater than seven micrometers. Outer peripheral edge thickness less than seven micrometers may be critical in certain embodiments to reduce or prevent epithelial undergrowth or ingrowth during the healing procedure. In certain embodiments, a corneal onlay comprises a lens body having an outer peripheral edge that has a thickness of about zero to five micrometers by design. For example, a design of the corneal onlay or a corneal onlay mold cavity may be configured to provide a corneal onlay outer peripheral edge having a thickness of zero to five micrometers. Thus, an embodiment of the present corneal onlays may have an outer peripheral edge that has a thickness corresponding to zero to five micrometers based on the outer peripheral edge thickness of a corneal onlay mold having a lens shaped cavity in the form of the corneal onlay lens body. In certain embodiments, the outer peripheral edge may have a thickness of about 1 micrometer or less, for example, about 0.7 micrometers, or about 0.5 micrometers, or about 0.2 micrometers.

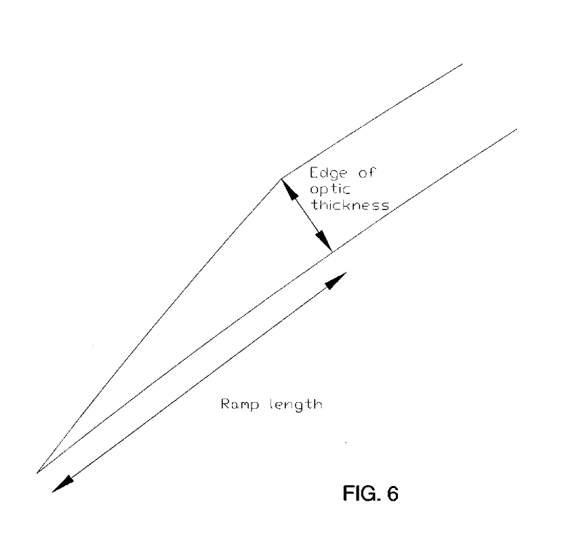

As discussed herein, embodiments of the present corneal onlays may have a ramp zone located between the outer peripheral edge 18 and the optic zone outer perimeter 22, as shown in FIG. 6. The ramp zone typically increases in thickness from the outer peripheral edge 18 toward the optic zone outer perimeter 22. The increase in thickness may be a constant increase or a non-constant increase. The change in thickness in the ramp zone is referred to herein as a ramp rate or ramping rate. The ramp rate is defined as the change in thickness per unit radial length of the ramp zone from an outer point to a radially inward point. Or, stated differently, the ramp rate can be defined as the change in thickness of the onlay per unit of ramp length (see FIG. 6).

Certain embodiments of the present onlays comprise a lens body having an outer peripheral edge that has a thickness less than about thirty micrometers (i.e., 0.03 mm) and a ramp zone that has a thickness that increases from the outer peripheral edge toward the optic zone at a rate of at least about 0.1 mm/mm. Such embodiments have a ramp rate of at least about 0.1 mm/mm. In additional embodiments, the ramp rate may be less than 0.1 mm/mm. For example, for a plano lens having an optic zone diameter of 7 mm and lens body diameter of 8 mm, the ramp rate could be 0.062 mm/mm. As another example, a plano lens (or plus power lens) having an lens body diameter of 12 mm, an optic zone diameter of 5 mm, and a center thickness of 20 micrometers, will have a ramp rate of 3 micrometers/mm. Thus, the present corneal onlays may comprise a lens body having a ramp rate of at least 3 micrometers/mm. It can be understood, that low or small ramp rates can be associated with large plano or plus power lenses with small center thicknesses and small optic zone diameters.

Additional embodiments of the present onlays may not have an outer peripheral edge thickness less than about thirty micrometers. For example, an embodiment of the present corneal onlays may have a ramp rate of at least about 0.1 mm/mm. In certain embodiments, the ramp rate of the ramp zone is greater than a rate of change in thickness of the optic zone of the lens body. For example, the optic zone may have a substantially constant thickness across the optic zone diameter and the rate of change in optic zone thickness is about zero mm/mm, and the ramp rate of the ramp zone is greater than zero mm/mm. Additional embodiments of such corneal onlays may have a ramp rate from about 0.1 mm/mm to about 0.5 mm/mm. For example, a corneal onlay may have a ramp rate from about 0.2 mm/mm to about 0.4 mm/mm.

In certain embodiments of the present onlays, the ramp zone has a length from the outer peripheral edge to the optic zone outer perimeter of at least about one hundred micrometers (i.e., 0.1 mm). In such an embodiment, if the ramp zone is symmetrically configured around the lens body, the total radial length of the ramp zone is about two hundred micrometers. In a further embodiment, the ramp zone has a radial length from about one hundred micrometers to about 3.5 mm.

Additional or alternative embodiments of the present corneal onlays comprise a lens body having a maximum diameter or a lens body diameter that is effective in permitting the lens body to cover the cornea of the eye without adversely interfering with the limbus surrounding the cornea. Such onlays can be distinguished from corneal inlays that are structured for placement in the corneal stroma since such corneal inlays do not impinge on the limbus of an eye. In certain embodiments, the present corneal onlays comprise a lens body having a maximum diameter of about eight millimeters. Corneal onlays may comprise a lens body having a maximum diameter no less than five millimeters and no greater than twelve millimeters, for example, certain embodiments may have a maximum diameter no less than six millimeters and no greater than nine millimeters.

The optic zone of the present corneal onlays is dimensioned or sized to be larger than the size of the pupil of the eye which the lens body is placed when the pupil is at its maximum dilation. In view of the disclosure herein, it can be understood then that the lens body is also larger than a maximally dilated pupil. The optic zone of certain embodiments of the present corneal onlays may have an optic zone diameter from about 5 mm to about 12 mm. For example, an embodiment of the present onlays may comprise a lens body having an optic zone with an optic zone diameter of about 7.5 mm. Another embodiment may have an optic zone from about 6.5 mm to about 7.5 mm.

In a specific embodiment, a corneal onlay comprises a lens body having a lens body diameter from about 7 mm to about 8 mm, an optic zone having an optic zone diameter from about 6.5 mm to about 7.5 mm, and a ramp rate of at least about 0.1 mm/mm. However, as discussed herein, the ramp rate of the present onlays may also be about 3 micrometers/mm or more.

Additional or alternative embodiments of the present corneal onlays may have a measurable sagittal depth, as shown in FIG. 5. The sagittal depth may be defined using either Equation I or Equation II below:

S=VH Equation I:

S=R−(square root of (R²−C²) Equation II:

In Equation I, S refers to the sagittal depth, VH refers to the vertical height of the corneal onlay when placed on a flat surface with the outer peripheral edge or edge region contacting the flat surface, and BCOR refers to the back central optic radius.

In Equation II, S=sagittal depth, R=radius of curve, and C=half of the chord diameter. Equation II may be useful in calculating the sagittal depth for a lens body having a back surface of a constant radius.

Alternatively, the sagittal depth can be measured or determined using other equations and methods known to persons of ordinary skill in the art.

The present corneal onlays may have a lens body diameter from about 6 mm to about 12 mm and a base curve from about 6 mm to about 9 mm. In certain embodiments, the base curve can be less than 6 mm. For example, the base curve can be between about 4 mm to about 6 mm. Thus, the present corneal onlays may comprise a lens body having a sagittal depth less than about 6 mm. In certain embodiments, the sagittal depth is at least 0.5 mm. In further embodiments, the sagittal depth is from about 0.5 mm to about 1.5 mm. In still further embodiments, the sagittal depth is from 1.005 mm to 1.316 mm. In at least one specific embodiment, a corneal onlay comprises a lens body having a maximum diameter or lens body diameter of about 7.5 mm, an optic zone diameter of about 7.0 mm, and a sagittal depth of about 1.300 mm.

Embodiments of the present corneal onlays may have a high water content in a hydrated state. For example, in certain embodiments, the lens body of a corneal onlay may have a water content of at least 50% (w/w). In further embodiments, the lens body has a water content of at least about 75% (w/w). In still further embodiments, the lens body has a water content from about 85% (w/w) to about 95% (w/w). Such high water content corneal onlays may be very flexible. For example, the high-water content corneal onlay lens bodies may have a modulus less than 1 MPa. In certain embodiments, the modulus of the lens body is from about 0.1 MPa to about 0.9 MPa. In further embodiments, the modulus of the lens body is at least about 0.2 MPa and is less than about 0.8 MPa. In still further embodiments, the modulus of the lens body is about 0.3 MPa, or about 0.4 MPa, or about 0.5 MPa, or about 0.6 MPa, or about 0.7 MPa. Compared to lens bodies having moduli of about 1 MPa, the present corneal onlays comprising lower modulus lens bodies can have substantially better fitting properties, for example, lens bodies having moduli lower than about 1 MPa can have enhanced conformation to the corneal surface, such as the surface of Bowman's membrane, and/or can have reduced lens movement relative to higher modulus lens bodies.

Corneal onlays comprising lens bodies with high water contents may comprise one or more hydrophilic polymers. As described herein, such corneal onlays may be formed from non-synthetic polymers or from biologically derived polymers. For example, high water content lens bodies may be formed from a polymerizable collagen-based composition.

The present corneal onlays are optically transparent or clear. For example, the lens body of a corneal onlay may be isorefractive with the cornea of a human eye. It has been reported that the refractive index of the human anterior stromal surface is 1.380. In certain embodiments, the lens body has a refractive index from about 1.300 to about 1.400. In further embodiments, the lens body has a refractive index from about 1.340 to about 1.350.

As discussed herein, in certain embodiments, the present corneal onlays may comprise lens bodies having ophthalmically desirable thicknesses. For example, the thickness of the outer peripheral edge or the lens edge region is effective in promoting or accommodating epithelial cell migration and/or proliferation over the lens edge, if desired. The lens bodies of the present corneal onlays may have other thicknesses effective to provide the desired treatment of refractive errors. For example, the lens body of a corneal onlay may have a center thickness less than about 0.09 mm (i.e., 90 micrometers). The center thickness refers to the thickness at the center of the lens body or the region of the lens body that is aligned with the optical axis of an eye in which the onlay is placed. Certain embodiments of the present corneal onlays comprise a lens body having a center thickness from about 0.03 mm to about 0.06 mm, for example, a lens body may have a center thickness from about 0.04 mm to about 0.05 mm.

Certain lens bodies of the present corneal onlays have a center thickness and peripheral thickness that are different. For example, a corneal onlay may comprise a lens body having a center thickness and a thickness at the optic zone outer perimeter that is not equal to the center thickness. For purposes of convenience, it may be understood that the optic zone has a center thickness and a peripheral thickness. The peripheral thickness may correspond to the thickness at a region of the optic zone periphery, as described herein, or the thickness at the optic zone outer perimeter. Depending on the type of refractive correction desired, the peripheral thickness may be less than, equal to, or greater than the center thickness. For example, a negative power corneal onlay will have a peripheral thickness that is greater than the center thickness. In comparison, a positive power corneal onlay will have a peripheral thickness that is less than the center thickness. Thus, an embodiment of the present corneal onlays comprises a lens body having an optic zone with a optic zone outer perimeter thickness that is less than the center thickness. Another embodiment of the present corneal onlays comprises a lens body having an optic zone with an optic zone outer perimeter thickness that is greater than the center thickness.

As an example, a corneal onlay may comprise a lens body having a center thickness from about 0.04 mm to about 0.05 mm, and an optic zone perimeter thickness less than 0.27 mm. As another example, a corneal onlay may comprise a lens body having a center thickness from about 0.03 mm to about 0.28 mm, and an optic zone perimeter thickness at least 0.03 mm. Additional examples may have center thicknesses greater than 0.05 mm. For example, certain corneal onlays may comprise a lens body that has a maximum center thickness of about 350 micrometers. Thus, it can be understood that the center thickness of the present onlays can have a maximum center thickness less than or equal to 350 micrometers. As another example, a corneal onlay comprising a lens body with a +10 diopter can have a center thickness of 0.283 mm.

The thicknesses of different regions or portions of the optic zone are selected so that the present corneal onlays provide the desired improvement in a patients vision. Thus, embodiments of the present corneal onlays, which may or may not include the other features described herein, may comprise a lens body having an optical power that, in combination with the corneal epithelium located over the anterior surface of the lens body, provides a desired vision correcting power to the patient.

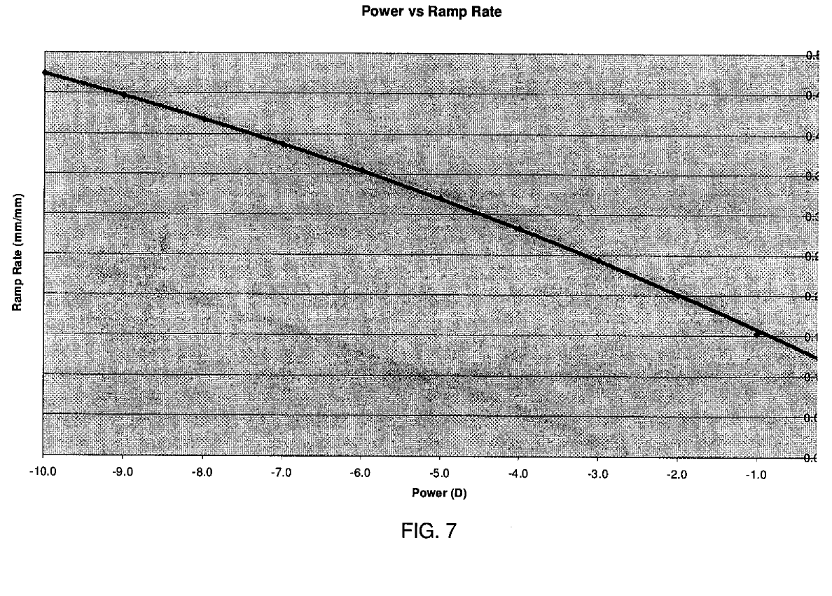

In addition, certain of the present corneal onlays comprise a lens body that has a certain ramp rate that varies as a function of optical power of the lens body. A graph showing the relationship between ramp rate (mm/mm) as a function of optical power (diopters) for examples of the present corneal onlays is shown in FIG. 7. The graph shown in FIG. 7 is based on an onlay having a lens body diameter of about 7.5 mm, an optic zone diameter of about 7.0 mm, a base curve of about 6.0 mm, and a refractive index of 1.346.

The present corneal onlays are dimensioned or structured to remain in a substantially fixed position when placed on or in a cornea of an eye. For example, after placement of the present corneal onlays onto Bowman's membrane of an eye, the onlay does not become decentered over time. In certain embodiments, the lens body of the present corneal onlay is dimensioned or structured to move no more than 0.50 mm or no more than 0.25 mm relative to the corneal epithelium or the optic axis of the eye. For example, the optical axis of the corneal onlay does not move more than 0.50 mm or not more than 0.25 mm relative to the optical axis of the eye. Such dimensions or structures can be determined by placing the present corneal onlays on the anterior or exterior surface of the corneal epithelium of the eye and the movement can be determined by measuring the movement on the epithelium resulting from blinking. This movement may be understood to be a blink-induced movement. Corneal onlays with desired fitting characteristics under the corneal epithelium can have a blink-induced movement less than 0.5 mm when placed on the anterior surface of the corneal epithelium. The movement values can be related to the amount of movement of an onlay located on a corneal epithelium resulting from a single blink or multiple blinks. For example, in certain embodiments, the onlay moves less than 0.5 mm when the eye on which the onlay is placed blinks once. In other embodiments, the onlay moves less than 0.5 mm when the eye on which the onlay is placed blinks 10 times. The movement value can be the maximum distance the onlay moves per blink, the maximum distance the onlay moves resulting from the total number of blinks, or can be the average or median distance the onlay moves from a plurality of blinks. Thus, the present corneal onlays with blink-induced movement values less than 0.5 mm can remain centered under the epithelium for extended periods of time, and preferably during the time period the corneal onlay is present in an eye of a patient. In certain embodiments, the anterior surface of the lens body is effective in being coupled to the overlying corneal epithelium. Such coupling may help reduce decentration or movement of the corneal onlay when placed in a cornea of an eye.

In further embodiments, the lens body of the present corneal onlays may comprise one or more marking elements. A marking element or marking elements are effective in facilitating positioning of the lens body on the cornea of the eye. These may be particularly helpful since the present lens bodies are optically transparent. The marking element may be permanently or temporarily attached to the lens body. In addition, marking elements may be provided which degrade over time so that the position of the lens can be monitored for a certain amount of time and after that time, the marking element will disappear. If a lens body includes one or more marking elements, the marking elements do not interfere with the patient's vision using the corneal onlay.

As discussed herein, certain aspects of the present corneal onlays relate to the methods of making corneal onlays. Such methods may be critical in producing corneal onlays that are substantially free of macroscopic and microscopic defects. Thus, additional or alternative embodiments of the present corneal onlays comprise lens bodies that are substantially free of microscopic defects. For example, such microscopic defect-free lens bodies may be free of microscopic defects as determined using a knife edge optical system. One example of a knife edge optical system useful to determine the presence or absence of microscopic defects is disclosed in U.S. Pat. No. 4,784,485

The present corneal onlays can be produced using a variety of different materials. Thus, the present corneal onlays can comprise different biocompatible materials. As discussed herein, the materials used in producing the present corneal onlays are preferably biocompatible, biostable, optically transparent, and otherwise clinically acceptable.

Certain embodiments of the present corneal onlays comprise a lens body that comprises non-donor corneal tissue. In certain embodiments, the lens body of the present corneal onlays is substantially or entirely free of donor corneal tissue.

Certain embodiments of the present corneal onlays comprise a lens body that comprises, consists essentially of, or consists entirely of, a synthetic polymeric component. For example, a lens body may be formed from one or more synthetic polymers, synthetic copolymers, or combinations thereof. In certain embodiments, the lens body may comprise a polynippam polymeric material. For example, certain lens bodies of the present corneal onlays may comprise a reaction product of a polynippam polymer and a biological polymeric material, such as collagen. In certain embodiments with one or more physical or structural features described herein, the lens body may comprise a fluoropolymer component. For example, a lens body of the present corneal onlays may comprise, consist essentially of, or consist entirely of fluoropolymer or fluropolymer derivative. One example of a useful fluropolymer derivative in certain of the present corneal onlays is a perfluoropolyether (PFPE) derivative that has high oxygen permeability, transparency, low refractive indices, and high oxidative stability, with minimal lipid deposits. Thus, certain configurations of the present corneal onlays may comprise lens bodies that comprise a PFPE derivative with a refractive index of about 1.344. Certain embodiments may comprise a lens body having anterior surface indentations, and/or pores. The pores of such lens bodies typically have a mean diameter less than 800 nanometers. For example, the pores may have a mean diameter from about 100 nanometers to about 400 nanometers. Or, a lens body may comprise pores with a minimum diameter of 100 nanometers and a maximum diameter of 400 nanometers. The anterior surface of the lens body may have a pore density of at least 0.5%. For example, if the pores have a mean diameter of about 100 nanometers, the anterior surface of the lens body can have a pore density from about 0.5% to about 15%.

Embodiments of these PFPE-based corneal onlays may have a modulus of about 1 MPa. Because PFPE macromers may be hydrophobic, it may be desirable to provide a hydrophilic coating on a surface of the lens body. The coating may be adsorbed or covalently coupled to the lens body. The coating comprises a material that is effective in promoting epithelial adhesion to the anterior surface of the lens body without negatively affecting nutrient transmissibility through the lens body. For example, in certain lens bodies, the coating comprises a glycoprotein component.

Examples of corneal onlay materials and lens bodies that may be useful in the present corneal onlays of certain novel physical features and the like disclosed herein include those disclosed in U.S. Pat. No. 6,454,800.

Certain embodiments of the present corneal onlays comprise a lens body that comprises, consists essentially of, or consists entirely of, a non-synthetic polymeric component. Or, stated differently, the lens body of the present corneal onlays may be substantially free of a synthetic polymeric component. For example, in certain embodiments, the present corneal onlays may comprise a lens body that is substantially or entirely free of a fluoropolymer component or comprises a material other than a perfluoropolyether or derivative thereof. The non-synthetic polymeric component may comprise, consist essentially of, or consist entirely of one or more biologically derived polymers. In at least one embodiment, the lens body comprises, consists essentially of, or consists entirely of cross-linked collagen polymers. When a biologically derived polymer is used in the present corneal onlays, the polymer is ophthalmically acceptable or stated differently, has an ophthalmically acceptable biocompatibility, biostability, transparency, and/or permeability. A biologically derived polymer may be understood to be a polymeric material obtained from a biological source or sources, or that may have chemical structures, including amino acid sequences, substantially identical to a polymeric material obtained from a biological source. In certain embodiments of the present corneal onlays, the lens body comprises, consists essentially or, or consists entirely of cross-linked recombinant collagen. Embodiments of the present corneal onlays include collagen-based lens bodies without any anterior surface treatment. In addition, embodiments of the present corneal onlays include lens bodies that comprise naturally occurring or non-synthetic polymers, and that maintain desirable optical properties such as transparency and optical power without physical remodeling of the lens body after the corneal epithelium has healed over the anterior surface of the lens body, and provide a reduced risk of infection or immunogenic response. For example, a lens body may comprise a major portion of collagen and may be effective in improving a patient's vision without remodelling of the lens body or developing epithelial abnormalities, such as undesirable epithelial thickening or thinning, and the like.

Embodiments of the present corneal onlays that comprise lens bodies formed from cross-linked collagen polymers are optically transparent. In certain embodiments, the cross-linked collagen polymers comprise collagen fibrils spaced apart so as to not occupy a space greater than half the wavelength of visible light. The present corneal onlays may comprise lens bodies having a transparency similar to that of a healthy human cornea. For example, the lens bodies may have a transparency greater than 80%. In certain embodiments, the transparency of the lens body may be about 85%, or about 90%, or about 95%, or about 97%. The transparency of the lens body may be measured or determined using routine methods known to persons of ordinary skill in the art.

Lens bodies formed of ophthalmically acceptable materials that promote epithelial attachment to the anterior surface of the lens body may not require a coating on the anterior surface of the lens body. For example, when a biologically derived polymeric material is used to form the lens body, a separate epithelial attachment coating may not be needed.

In addition, embodiments of the present corneal onlays may comprise lens bodies that have substantially smooth surfaces, including the anterior surface. For example, the surface of the onlay may appear smooth when view at a microscopic scale or using a device such as a knife edge optical system. In certain embodiments, the lens body has an anterior surface that includes no pores having diameters greater than 800 nanometers, or no pores having diameters greater than 400 nanometers, or no pores having diameters greater than 100 nanometers. In certain embodiments, the anterior surface of the lens body is free of any visually identifiable pores. Such pore-less lens body anterior surfaces may be beneficial when using non-synthetic polymers, such as the biologically derived polymers disclosed herein. For example, porosity may not be critical with lens bodies that have relatively high water contents, such as some of the lens bodies described herein.

Similarly, the anterior surface of the lens body may be substantially or entirely free of surface indentations, such as microscopic surface indentations.

Still further embodiments of the present corneal onlays may comprise a lens body that comprises a protein component. The protein component may comprise a single type of protein, two or more proteins, or a hybrid of two or more proteins. As one example, a lens body may comprise, consist essentially of, or consist entirely of elastin and fibronectin components. For example, some potential corneal onlay materials useful in certain of the present corneal onlays include those materials disclosed in U.S. Pat. Publication No. 20050196427.

Another example of a material useful in certain of the present corneal onlays include alkylacrylate polymers and the like. For example, a corneal onlay may comprise a lens body that comprises a poly hydroxyethlymethacrylate (HEMA) component. The poly HEMA lens body may have a surface modification effective in facilitating or promoting attachment of a surface coating. For example, the surface of the lens body may be modified to form aldehyde functional groups that are reactive with collagen, such as Type I collagen.

The present corneal onlays may comprise a lens body that includes an epithelial migrating component, such as when the epithelium is abraded during the implantation procedure, or includes not epithelial migrating component, such as when the corneal onlay is placed under an epithelial flap or in an epithelial pocket.

In addition, embodiments of the present corneal onlays may include an adhesive component on the posterior surface of the lens body. The adhesive component may be provided over the entire posterior surface or one or more portions thereof. For example, an adhesive component may be provided along the edge of the posterior surface of the lens body or just in a central region of the posterior surface of the lens body. The adhesive component is preferably biocompatible, and in certain embodiments, the adhesive component may be biodegradable. One example of a biocompatible adhesive component is fibronectin. Other adhesive components may include extracellular matrix proteins to effective in coupling to Bowman's membrane. Other embodiments of the present corneal onlays comprise lens bodies without an adhesive component on the posterior surface of the lens body.

The present lenses can be designed using computer software, as understood by persons of ordinary skill in the art. The materials used to form the lenses, such as the corneal onlay precursor composition, can be processed using conventional techniques to form the corneal onlay. When polymerizable corneal onlay precursor compositions are used, such as compositions comprising one or more monomer components, macromer components, and the like, the composition can be polymerized or cured to form a corneal onlay using conventional polymerization methods, including the use of ultraviolet radiation, and the like, such as thermal, irradiation, chemical, and electromagnetic radiation. The materials may be placed in a lens mold, which can be produced by a mold insert in an injection molding apparatus. After forming the present corneal onlays, they can be packaged in a sterile condition for use.

In at least one aspect, a method of making a corneal onlay is provided. Such a method is effective in making a clinically acceptable lens body, as described herein. For example, the method is effective in making a corneal onlay that is substantially free of microscopic defects.

It has been discovered that when polymerizable materials are used in the production of corneal onlays, the amount of time used to dispense the polymerizable composition into a mold cavity and to seal the mold cavity can be critical. For example, if the timing is not controlled, the polymerizable composition may prematurely polymerize which frequently, if not always, results in microscopic defects, as described herein. By controlling the timing, as described herein, the presence of microscopic defects is greatly reduced compared to corneal onlays produced using uncontrolled time periods, and preferably, microscopic defects are eliminated. By controlling the timing of the dispense of the polymerizable composition into a mold cavity and the sealing of the mold cavity, the yield of clinically acceptable lens bodies is greatly enhanced or increased relative to procedures that do not control the dispense and seal time. Surprisingly, it has been discovered that manual methods of dispensing polymerizable compositions into mold cavities and sealing the mold cavities result in substantial microscopic defects that are not visible using a microscope but that are visible using a knife edge optical system, as discussed herein. Such manually produced corneal onlays have lens bodies with microscopic defects that render them non-clinically acceptable and unsuitable for human use. Manual production methods greatly increases the variation in timing and does not provide sufficient control of polymerization to prevent the formation of microscopic defects.

In certain embodiments of the present methods, a method of making a corneal onlay comprises placing a polymerizable corneal onlay precursor composition in a cavity of a first corneal onlay mold member. The first corneal onlay mold member may be understood to be a female corneal onlay mold member. The first corneal onlay mold member has a cavity with a concave surface that is the negative of a surface, such as the anterior surface, of the corneal onlay produced in the mold member. In certain embodiments, the concave surface has an optically smooth surface, that is the surface is sufficiently smooth to produce a corneal onlay surface that is sufficiently smooth for use in an eye of a human patient.

The method also comprises placing a second corneal onlay mold member in contact with the first corneal onlay mold member to form a corneal onlay shaped cavity containing the polymerizable corneal onlay precursor composition. The second corneal onlay mold member may be understood to be a male corneal onlay mold member. The second corneal onlay mold member has a convex surface that is the negative of a surface, such as the posterior surface, of the lens body of the corneal onlay. Similar to the concave surface of the first corneal onlay mold member, the convex surface of the second corneal onlay mold member has an optically smooth surface in certain embodiments. The combination of the first corneal onlay mold member and the second corneal onlay mold member is defined herein as a corneal onlay mold. Therefore, it can be understood that a corneal onlay mold has a corneal onlay mold shaped cavity. In certain embodiments, the first and second corneal onlay mold members are identically structured, which can provide an advantage of reducing inventory and machinery needed for producing the mold members. In other embodiments, the first and corneal onlay mold member have different structural configurations.

The second corneal onlay mold member is placed in contact with the first corneal onlay mold member within an amount of time effective in avoiding formation of surface features indicative of premature polymerization of the polymerizable corneal onlay precursor composition. Or, stated differently, the placement of the second corneal onlay mold member and the first corneal onlay mold member together is done quickly to prevent or reduce premature polymerization of the polymerizable composition. For example, in certain embodiments of the present methods, it is desirable to only allow polymerization to occur when the polymerizable composition is in contact with the optically smooth concave and convex surfaces.

After placing the second corneal onlay mold member in contact with the first corneal onlay mold member, the method comprises polymerizing the polymerizable corneal onlay precursor composition to form a polymerized corneal onlay. The polymerization can be performed using any conventional polymerization process, as described herein.

In certain embodiments of the method, the second corneal onlay mold member is placed in contact with the first corneal onlay mold member within about sixty seconds after placing the polymerizable corneal onlay precursor composition in the cavity of the first mold member. In further embodiments, the amount of time to place the polymerizable composition in the first mold member cavity and to place the second mold member in contact with the first mold member is less than sixty seconds and does not vary by more than thirty percent from mold to mold or batch of onlays to batch of onlays. Thus, with the present methods, clinically acceptable, such as microscopic defect-free, corneal onlays can be produced in commercially acceptable amounts with high yield rates. For example, the clinically acceptable, or human quality, corneal onlays can be produced at rates where at least 5% of the produced onlays are clinically acceptable. The present corneal onlays can be produced to meet supply and demand requirements, as necessary.

The amount of polymerizable corneal onlay precursor composition placed or dispensed in a corneal onlay mold member cavity may vary, and usually will vary depending on the particular optical power needed, and the size of the corneal onlay. In certain embodiments, the amount of the polymerizable corneal onlay precursor composition placed in the cavity of the first corneal onlay mold member is from about 2 microliters to about 40 microliters. For example, certain corneal onlays are produced by placing about 5 microliters of the polymerizable corneal onlay precursor composition into the first corneal onlay mold member cavity.

In certain embodiments, the placing steps of the present methods are performed at temperatures effective in delaying premature polymerization of the polymerizable corneal onlay precursor composition. When thermal polymerization steps are used to form the corneal onlay, the temperature used before polymerization is less than the temperature used to polymerize the precursor composition and preferably is less than the denaturing temperature of the precursor composition, if known. The temperature used before polymerization is also preferably greater than the freezing temperature of the precursor composition. In certain methods, the placing steps are performed at a temperature less than about twenty degrees Celsius (e.g., room temperature) and greater than the freezing temperature of the polymerizable corneal onlay precursor composition. In further embodiments, the placing steps are performed at a temperature from about 0° C. to about 5° C.

The polymerizing step may involve thermal curing of the precursor composition. In one embodiment, the polymerizing comprises maintaining the polymerizable corneal onlay precursor composition at a temperature greater than the temperature of the composition when the composition was placed in the cavity of the first mold member. For example, when the placing occurs at a temperature less than room temperature, the polymerizing may comprise maintaining the polymerizable corneal onlay precursor composition at room temperature until the composition is sufficiently polymerized to form a polymerized corneal onlay. In certain embodiments, the polymerizing comprises maintaining the polymerizable corneal onlay precursor composition at a temperature from about 20 degrees C. to about 40 degrees C. for at least 1.5 minutes. In further embodiments, the composition is maintained at the desired temperature for at least 10 minutes. In one embodiment, the polymerizing comprises maintaining the polymerizable corneal onlay precursor composition at a temperature from about 20° C. to about 40° C. for a time from about 18 hours to about 24 hours.

The present methods may also comprise separating the first corneal onlay mold member and the second corneal onlay mold member. Or, stated differently, the method may comprise demolding the corneal onlay mold. The method may also comprise hydrating the polymerized corneal onlay. The hydrating may occur before or after the demolding of the corneal onlay mold. Hydrating may be effective in facilitating demolding of the corneal onlay mold and/or may be effective in facilitating delensing the corneal onlay from one of the mold members.

The present methods may also comprise sterilizing the polymerized corneal onlay. For example, the polymerized corneal onlay can be sterilized using heat, including autoclaving, or using radiation, such as gamma radiation, ultraviolet radiation, or electron-beam radiation. The sterilization can occur when the onlay is present in a package, which may or may not be sealed during the sterilization.

As discussed herein, the timing of the placement of the precursor composition in the first mold member cavity and the placement of the second mold member in contact with the first mold member can be critical. Thus, at least one of the present steps is automated or semi-automated. Automation greatly enhances the control and timing in the manufacture of the present corneal onlays compared to other methods disclosed using manual methods.

The present methods may be particularly useful in certain polymerizable compositions relative to other polymerizable compositions. In certain embodiments, the polymerizable composition used in the foregoing methods comprises a collagen component and a collagen-cross-linker component. In certain embodiments, the collagen component comprises recombinant collagen.

The corneal onlays produced using the foregoing methods are not only free of macroscopic defects, but are also substantially free of microscopic defects. For example, it has been discovered that the present methods substantially reduce the amount of microscopic defects of corneal onlays when the corneal onlays are examined using a knife edge optical system, as compared to manually produced corneal onlays using the same materials and examined using the same knife edge optical system.

Examples of defects associated with methods that do not control the placing times, as recited in the present methods, include surface irregularities, bubbles, particles, tears, edge defects, blemishes, opacities, flash rings, flash ring portions, and combinations thereof. Thus, with the present methods, corneal onlays are formed that are substantially free of a defect selected from the group consisting of surface irregularities, bubbles, particles, tears, edge defects, blemishes, opacities, flash ring, flash ring portions, and combinations thereof.

As discussed herein, the present polymerized corneal onlay produced with the present methods may comprise a lens body having a substantially smooth anterior surface and posterior surface.

With the present methods, commercially acceptable rates of producing corneal onlays can be obtained. For example, at least about 5% of a batch of corneal onlays produced with the present methods are clinically acceptable. For example, 5% or more of a batch of corneal onlays are substantially free of microscopic defects. In certain embodiments, the yield rate or clinically acceptable corneal onlays is at least 40%, at least 50%, or at least 60%, or at least 70%, or at least 80%, or at least 90%. Such success rates are achievable by automating, or partially automating, one or more steps of the present methods.

The present corneal onlays are used to correct or treat refractive errors, among other things. The present corneal onlays can improve a patient's near sightedness or far sightedness. The present corneal onlays improve a patient's vision by changing the refractive power of the eye in which the lens body is placed. The refractive power can be changed by altering the curvature of the anterior corneal surface, altering the refractive index of the material, or the combination thereof.

Thus, an aspect of the present invention relates to methods of improving or enhancing vision of a patient. The present methods comprise placing any of the present corneal onlays, such as a corneal onlay comprising a clinically acceptable lens body on Bowman's membrane of an eye of a human patient. The present methods may also comprise removing or separating the corneal epithelium from Bowman's membrane prior to placing the corneal onlay thereon. Certain embodiments comprise abrading the corneal epithelium. The corneal epithelium can be abraded or otherwise removed using a trephine, including a vacuum trephine, alcohol, or other similar mechanical or chemical epithelial remover. The depth of the abrasion is substantially equal to the thickness of the corneal epithelium, for example, the depth of abrasion may be about 50 micrometers. When the corneal epithelium is abraded and the corneal onlay is placed on an exposed Bowman's membrane, epithelial cell growth and coverage begins about 1-2 days after the corneal onlay is placed on Bowman's membrane. Complete coverage of the anterior surface of the corneal onlay lens body is achieved within about 6-8 days, such as about 7 days. A multilayered stratified epithelium is achieved within about 10 days to within about 38 days after placement of the corneal onlay on Bowman's membrane.

In another embodiment, a method comprises separating a living layer of corneal epithelium from Bowman's membrane before placing the corneal onlay on Bowman's membrane. The separating may comprise forming a corneal epithelial flap or forming a epithelial pocket. The flap or pocket can be produced using an epithelial delamination device, such as a microkeratome or other similar instrument.

The corneal onlay may be placed on an exposed Bowman's membrane and an epithelial flap may be placed back over the anterior surface of the corneal onlay lens body, or if the corneal onlay is placed in an epithelial pocket, the corneal onlay will remain in the pocket after placement therein. In certain embodiments, the corneal onlay may be inserted into the epithelial pocket in a folded configuration. In other embodiments, the corneal onlay can be inserted in an unfolded configuration. In addition, certain corneal onlays can be inserted in a pocket or on Bowman's membrane in an unhydrated state or partially hydrated state, and allowed to swell when located on Bowman's membrane.

The corneal onlay remains optically transparent when placed on Bowman's membrane. Significantly, the transparency is maintained for several months, years, or even the life of the patient after placement of the corneal onlay in the cornea of the eye.

In certain methods, a method comprises cooling the eye of the patient during the surgical or implantation procedure. For example, the method may comprise applying cooled saline or other aqueous medium to the eye prior to or during the implantation of the corneal onlay. In certain embodiments, the temperature of the fluid is less than 35° C. For example, the temperature of the fluid is from about 4° C. to about 34° C. In certain embodiments, the temperature of the fluid before application to the eye is about 5° C., about 10° C., about 15° C., about 20° C., about 25° C., or about 30° C. In one specific embodiment, the temperature of the fluid immediately before application to the eye is between 30° C. and 35° C.

In certain methods, a method comprises applying a healing agent to the eye of the patient to promote epithelial healing. For example, a healing agent may be applied to the incision of an epithelial flap or epithelial pocket. The healing agent may facilitate closure of the incision, and/or may promote growth or proliferation of the epithelium. When abrasion is used to expose Bowman's membrane, the healing agent may promote epithelial growth, proliferation, migration, or attachment over the anterior surface of the corneal onlay lens body.

In an additional embodiment, any of the present corneal onlays can be further modified or processed after placement on the eye. For example, a method may include post-operatively correcting or changing the optical power of the corneal onlay lens body. Such methods may help adjust the optical power of the onlay to provide a desired vision improvement to the patient. In certain embodiments, the post-operative changing of optical power can be achieved using radiation, such as laser radiation or ultraviolet radiation.

In the present methods, the corneal onlay remains centered on the eye for at least one day after placement thereon.

The present methods may include an optional step of suturing the lens body to the eye. Other methods may attach the lens body without suturing the lens body to the eye. Some embodiments of the present method may include using a conjunctival graft to secure the lens body to the eye, and other embodiments may secure the lens body to the eye without a conjunctival graft.

In the present methods, the corneal onlay exhibits complete epithelialization within about 30 days after the implantation procedure. For example, complete epithelialization (e.g., formation of a healed multi-layered corneal epithelium) can be obtained with 20 days, within 10 days, within 7 days, within 5 days, within 3 days, within 1 day, within 12 hours, within 6 hours, within 3 hours, or within 1 hour after the implantation procedure. Shorter time periods for complete epithelialization are often observed when epithelial flaps or epithelial pockets are formed to provide access to Bowman's membrane.

Aspects of the present invention also relate to the use of any one or more of the present corneal onlays as a clinically acceptable vision improving device, such as refractive error correcting devices. In addition, aspects of the present invention relate to the use of a lens forming material or polymeric material in the manufacture of any one or more of the present corneal onlays for improving vision of a patient, such as for improving or correcting one or more refractive errors of a patient.

Another aspect of the present invention relates to methods for identifying or screening clinically acceptable corneal onlays for use in a human patient. Thus, clinically acceptable corneal onlays can be identified from a batch of two or more corneal onlays that may or may not be clinically acceptable.

In one embodiment, a method may comprise examining a potentially clinically acceptable corneal onlay for microscopic defects and selecting or identifying corneal onlays that are substantially free of microscopic defects as clinically acceptable corneal onlays.

Another embodiment comprises placing a potentially acceptable corneal onlay on a layer of epithelial cells at a first position, such as a layer of cultured epithelial cells or on the exterior or anterior surface of a living corneal epithelium, and identifying a clinically acceptable corneal onlay from a plurality of potentially acceptable corneal onlays, each onlay located on a layer of epithelial cells, if the onlay moves less than 0.50 mm from the first position. As discussed herein, the movement can be blink-induced movement resulting from one or more blinks when the onlay is placed on a cornea of an eye.

In view of the disclosure herein, embodiments of the present invention include corneal onlays comprising clinically acceptable lens bodies. Additional or alternative embodiments include corneal onlays comprising a lens body having outer peripheral edge thicknesses effective in facilitating growth, proliferation, migration, and/or healing of the corneal epithelium over the anterior surface of the lens body.

Additional or alternative embodiments of the present invention include corneal onlays comprising lens bodies having ramp rates effective in facilitating growth, proliferation, migration, and/or healing of the corneal epithelium over the anterior surface of the lens body.

Additional or alternative embodiments of the present invention include corneal onlays comprising lens bodies having sagittal depths effective in providing a desired vision improvement to a patient without substantial discomfort to the patient.

Additional or alternative embodiments of the present invention include corneal onlays comprising lens bodies having power profiles effective in providing a desired improvement or treatment of refractive error of an eye of a patient. Such power profiles take into account effects caused by the overlying corneal epithelium.

Methods of making and using the present corneal onlays are also encompassed.

In one specific embodiment, a corneal onlay comprises a lens body that consists essentially of cross-linked collagen. The lens body has a water content of about 90% (w/w) and does not include any surface modification. The lens body has a center thickness of about 40 micrometers to about 50 micrometers and an outer peripheral edge of approximately 0 micrometers. The lens body has a refractive index of about 1.34 and appears optically transparent. The lens body is substantially free of microscopic defects indicative of premature polymerization of the corneal onlay precursor composition.

In another embodiment, the aforementioned corneal onlay comprises a clinically acceptable lens body. The corneal onlay was inserted into a corneal epithelial pocket formed on a cornea of an eye using a microkeratome. The corneal onlay remains centered within the pocket after the procedure. The corneal epithelium completely healed within two days after the operation. The transparency of the lens body remained clinically acceptable.

Although the disclosure herein refers to certain specific embodiments, it is to be understood that these embodiments are presented by way of example and not by way of limitation. The intent of the foregoing detailed description, although discussing exemplary embodiments, is to be construed to cover all modifications, alternatives, and equivalents of the embodiments as may fall within the spirit and scope of the invention as defined by the additional disclosure.

A number of publications and patents have been cited hereinabove. Each of the cited publications and patents are hereby incorporated by reference in their entireties.

What is claimed is:

1. A corneal onlay, comprising:
a clinically acceptable lens body having an anterior surface and a posterior surface, the lens body being effective in permitting a corneal epithelium to completely heal and cover the anterior surface of the lens body and in retaining an ophthalmically acceptable transparency after implantation of the lens body onto the cornea of an eye of a human patient.

2. The corneal onlay of claim 1, wherein the lens body has an optic zone having an optic zone outer perimeter, an outer peripheral edge located at the junction of the anterior surface and the posterior surface and spaced apart from the optic zone outer perimeter, and a ramp zone located between the outer peripheral edge and the optic zone outer perimeter.

3. The corneal onlay of claim 2, wherein the outer peripheral edge has a thickness less than a maximum dimension of a corneal epithelial cell.

4. The corneal onlay of claim 2, wherein the outer peripheral edge has a thickness less than 7 micrometers.

5. The corneal onlay of claim 2, wherein the outer peripheral edge has a thickness less than about 0.03 mm and the ramp zone has a thickness that increases from the outer peripheral edge toward the optic zone at a rate of at least about 3 micrometers/mm.

6. The corneal onlay of claim 2, wherein the outer peripheral edge has a thickness corresponding to 0-5 micrometers based on the outer peripheral edge thickness of a corneal onlay mold having a lens shaped cavity in the form of the lens body.

7. The corneal onlay of claim 2, wherein the ramping zone has a length from the outer peripheral edge to the optic zone outer perimeter of at least about 0.1 mm.

8. The corneal onlay of claim 2, wherein the ramping zone has a length from the outer peripheral edge to the optic zone outer perimeter from about 0.1 mm to about 3.5 mm

9. The corneal onlay of claim 2, wherein the lens body has a ramp rate defined as the rate of change in thickness of the lens body from the outer peripheral edge to the optic zone outer perimeter, the ramp rate being greater than a rate of change in thickness of the optic zone of the lens body.

10. The corneal onlay of claim 9, wherein the ramp rate is at least about 0.1 mm/mm.

11. The corneal onlay of claim 9, wherein the ramp rate is between about 0.1 mm/mm and about 0.5 mm/mm.

12. The corneal onlay of claim 11, wherein the ramp rate is from about 0.2 mm/mm to about 0.4 mm/mm.

13. The corneal onlay of claim 9, wherein the ramp rate remains substantially constant from the outer peripheral edge to the optic zone outer perimeter.

14. The corneal onlay of claim 1, wherein the lens body has a maximum diameter effective in completely covering the cornea of the eye without adversely interfering with the limbus surrounding the cornea.

15. The corneal onlay of claim 14, wherein the lens body has a maximum diameter of about 8 mm.

16. The corneal onlay of claim 2, wherein the optic zone is larger than the size of the pupil of the eye on which the lens body is placed when the pupil is at its maximum dilation.

17. The corneal onlay of claim 16, wherein the optic zone has a diameter from about 5 mm to about 12 mm.

18. The corneal onlay of claim 16, wherein the optic zone has a diameter of about 7.5 mm.

19. The corneal onlay of claim 9, wherein the lens body has a diameter from about 7 mm to about 8 mm, the optic zone has a diameter from about 6.5 mm to about 7.5 mm, and the ramp rate is at least about 0.1 mm/mm.

20. The corneal onlay of claim 1, wherein the lens body has a sagittal depth of at least 0.5 mm.

21. The corneal onlay of claim 1, wherein the lens body has a sagittal depth less than about 6 mm.

22. The corneal onlay of claim 1, wherein the lens body has a sagittal depth from about 0.5 mm to about 1.5 mm.

23. The corneal onlay of claim 1, wherein the lens body has a sagittal depth from 1.005 mm to 1.316 mm.

24. The corneal onlay of claim 1, wherein the lens body has a maximum diameter of about 7.5 mm, an optic zone diameter of about 7.0 mm, and a sagittal depth of about 1.300 mm.

25. The corneal onlay of claim 1, wherein the lens body has a base curve from about 4 mm to about 9 mm.

26. The corneal onlay of claim 25, wherein the lens body has a maximum diameter from about 6 mm to about 12 mm.

27. The corneal onlay of claim 1, wherein the lens body has a water content of at least about 75% (w/w).

28. The corneal onlay of claim 27, wherein the lens body has a water content from about 85% (w/w) to about 95% (w/w).

29. The corneal onlay of claim 1, wherein the lens body has a refractive index from about 1.300 to about 1.400.

30. The corneal onlay of claim 29, wherein the lens body has a refractive index from about 1.340 to about 1.350.

31. The corneal onlay of claim 1, wherein the lens body is dimensioned to move no more than 0.25 mm relative to the corneal epithelium of the eye.

32. The corneal onlay of claim 2, wherein the lens body has a center thickness less than about 0.35 mm.

33. The corneal onlay of claim 32, wherein the lens body has a center thickness from about 0.03 mm to about 0.06 mm.

34. The corneal onlay of claim 32, wherein the lens body has a center thickness and a thickness at the optic zone outer perimeter that is not equal to the center thickness.

35. The corneal onlay of claim 34, wherein the optic zone outer perimeter thickness is less than the center thickness.

36. The corneal onlay of claim 34, wherein the optic zone outer perimeter thickness is greater than the center thickness.

37. The corneal onlay of claim 34, wherein the center thickness is from about 0.04 mm to about 0.05 mm, and the optic zone perimeter thickness is less than 0.27 mm.

38. The corneal onlay of claim 34, wherein the optic zone outer perimeter thickness is at least 0.03 mm and the center thickness is greater than 0.03 mm and less than about 0.35 mm.

39. The corneal onlay of claim 1, wherein the lens body comprises non-donor corneal tissue.

40. The corneal onlay of claim 1, wherein the lens body is substantially free of a synthetic polymeric component.

41. The corneal onlay of claim 1, wherein the lens body is free of a fluoropolymer component.

42. The corneal onlay of claim 1, wherein the lens body consists essentially of cross-linked collagen polymers.

43. The corneal onlay of claim 1, wherein the lens body comprises recombinant collagen.

44. The corneal onlay of claim 1, wherein the lens body includes at least one marking effective in facilitating positioning of the lens body on the cornea of the eye.

45. The corneal onlay of claim 1, wherein the lens body has an optical power that in combination with the corneal epithelium located over the anterior surface of the lens body provides a desired vision correcting power to the patient.

46. The corneal onlay of claim 1, wherein the lens body comprises cross-linked collagen polymers comprising collagen fibrils spaced apart so as to not occupy a space greater than half the wavelength of visible light.

47. The corneal onlay of claim 1, wherein the lens body is substantially free of microscopic defects.

48. The corneal onlay of claim 47, wherein the lens body is substantially free of microscopic defects as determined by a knife edge optical system used to inspect the corneal onlay.

49. A method of making a corneal onlay, comprising:
placing a polymerizable corneal onlay precursor composition in a cavity of a first corneal onlay mold member;
placing a second corneal onlay mold member in contact with the first corneal onlay mold member to form a corneal onlay shaped cavity containing the polymerizable corneal onlay precursor composition, the second corneal onlay mold member being placed in contact with the first corneal onlay mold member within an amount of time effective in avoiding formation of surface features indicative of premature polymerization of the polymerizable corneal onlay precursor composition; and
polymerizing the polymerizable corneal onlay precursor composition to form a polymerized corneal onlay.

50. The method of claim 49, wherein the second corneal onlay mold member is placed in contact with the first corneal onlay mold member within about sixty seconds after placing the polymerizable corneal onlay precursor composition in the cavity of the first mold member.

51. The method of claim 49, wherein the amount of the polymerizable corneal onlay precursor composition placed in the cavity of the first corneal onlay mold member is from about 2 microliters to about 40 microliters.

52. The method of claim 51, wherein the amount of the polymerizable corneal onlay precursor composition placed in the cavity of the first corneal onlay mold member is about 5 microliters.

53. The method of claim 49, wherein the placing steps are performed at a temperature less than the denaturing temperature of the polymerizable corneal onlay precursor composition and greater than the freezing temperature of the polymerizable corneal onlay precursor composition.

54. The method of claim 53, wherein the placing steps are performed at a temperature from about 0 degrees C. to about 5 degrees C.

55. The method of claim 49, wherein the polymerizing comprises maintaining the polymerizable corneal onlay precursor composition at a temperature greater than the temperature of the composition when the composition was placed in the cavity of the first mold member.

56. The method of claim 55, wherein the polymerizing comprises maintaining the polymerizable corneal onlay precursor composition at a temperature from about 20 degrees C. to about 40 degrees C. for a time period of at least 1.5 minutes.

57. The method of claim 55, wherein the polymerizing comprises maintaining the polymerizable corneal onlay precursor composition at a temperature from about 20 degrees C. to about 40 degrees C. for a time period of at least 10 minutes.

58. The method of claim 55, wherein the polymerizing comprises maintaining the polymerizable corneal onlay precursor composition at a temperature from about 20 degrees C. to about 40 degrees C. for a time period from about 18 hours to about 24 hours.

59. The method of claim 49, further comprising hydrating the polymerized corneal onlay.

60. The method of claim 49, further comprising separating the first corneal onlay mold member and the second corneal onlay mold member.

61. The method of claim 49, further comprising sterilizing the polymerized corneal onlay.

62. The method of claim 49, wherein at least one of the steps is semi-automated.

63. The method of claim 49, wherein at least one of the steps is automated.

64. The method of claim 49, wherein the polymerizable corneal onlay precursor composition comprises a collagen component and a collagen cross-linker component.

65. The method of claim 64, wherein the collagen component comprises recombinant collagen.

66. The method of claim 49, wherein the polymerized corneal onlay is substantially free of microscopic and macroscopic defects.

67. The method of claim 49, wherein the polymerized corneal onlay is substantially free from a defect selected from the group consisting of surface irregularities, bubbles, particles, tears, edge defects, blemishes, opacities, flash ring, flash ring portions, and combinations thereof.

68. The method of claim 49, wherein the polymerized corneal onlay has a substantially smooth anterior surface and posterior surface.

69. The method of claim 49 which is effective at producing clinically acceptable polymerized corneal onlays for placement in a cornea of a human patient at a rate of at least about 5%.

70. A method of improving vision of a patient, comprising placing a corneal onlay on Bowman's membrane of the cornea of an eye of a patient,
wherein the corneal onlay comprises a clinically acceptable lens body having an anterior surface and a posterior surface, the lens body being effective in permitting a corneal epithelium to completely heal and cover the anterior surface of the lens body and in retaining an ophthalmically acceptable transparency after implantation of the lens body onto the cornea of an eye of a human patient.

71. The method of claim 70, further comprising abrading corneal epithelium of the eye of the patient before placing the corneal onlay on Bowman's membrane.

72. The method of claim 70, further comprising separating a living layer of corneal epithelium from Bowman's membrane before placing the corneal onlay on Bowman's membrane.

73. The method of claim 70, further comprising forming an epithelial pocket of the cornea before placing the corneal onlay on Bowman's membrane.

74. The method of claim 70, further comprising cooling the eye of the patient.

75. The method of claim 70, wherein the corneal onlay remains optically transparent while placed on Bowman's membrane.

76. The method of claim 70, further comprising applying a healing agent to the eye of the patient to promote epithelial healing.

77. The method of claim 70, wherein the corneal onlay remains centered on the cornea of the eye for at least one day after placement thereon.

78. A method for identifying a clinically acceptable corneal onlay for use in a human patient, comprising:
placing a potentially acceptable corneal onlay on a layer of epithelial cells on a cornea of an eye at a first position;
identifying a clinically acceptable corneal onlay from a plurality of potentially acceptable corneal onlays, each located on a layer of epithelial cells on a cornea of an eye, if the onlay moves less than 0.25 mm from the first position.
